(19) United States
(12) Patent Application Publication
(10) Pub. No.: US 2019/0079705 A1
(43) Pub. Date: Mar. 14, 2019

(54) PRINTING DATA OUTPUT METHOD, PRINTING DATA OUTPUT PROGRAM, AND PRINTING DATA OUTPUT SYSTEM

(71) Applicant: FUJITSU LIMITED, Kawasaki-shi (JP)

(72) Inventors: Junki Hakamata, Yokohama (JP); Takumi Toyoshima, Yokohama (JP); Etsushi Fujita, Kawasaki (JP); Takahiko Sato, Kawasaki (JP)

(73) Assignee: FUJITSU LIMITED, Kawasaki-shi (JP)

(21) Appl. No.: 16/189,411

(22) Filed: Nov. 13, 2018

Related U.S. Application Data
(63) Continuation of application No. PCT/JP2016/064522, filed on May 16, 2016.

(51) Int. Cl. G06F 3/12; H04N 1/00; H04N 1/21

(52) U.S. Cl. CPC G06F 3/1205; G06F 3/1288; H04N 1/21; H04N 1/00206; G06F 3/1238

(57) ABSTRACT

A printing data output method executed by a server device, which causes the server device to execute a process includes receiving first intermediate format data generated based on printing data from a terminal, identifying one or more printers in response to reception of information on a print output destination of the printing data, determining whether the first intermediate format data matches the printer, generating second intermediate format data that matches the printer from the first intermediate format data in accordance with a result of the determination, and transmitting, to the printer, the second intermediate format data or print format data converted by the server device based on the second intermediate format data when the second intermediate format data is generated.

### CROSS-REFERENCE TO RELATED APPLICATION

This application is a continuation application of International Application PCT/JP2016/064522 filed on May 16, 2016 and designated the U.S., the entire contents of which are incorporated herein by reference.

### FIELD

The embodiments discussed herein are related to a printing data output method, a printing data output program, and a printing data output system.

### BACKGROUND

There is a system in which a terminal transmits printing data to a printer that performs printing in accordance with the printing data. Recently, as data transmitted from a terminal to a printer, highly versatile intermediate format data allowed to be printed in a plurality of types of printers is used.

The intermediate format data is highly versatile printing data, and the intermediate format data is generated, for example, by software such as a printer driver executed in a terminal. Here, unique print setting may be performed to intermediate format data in some pieces of software such as printer drivers each of which generates the intermediate format data.

When unique print setting is performed to intermediate format data, the unique print setting may not be correctly interpreted in some printers that are print output destinations. Even when unique print setting is not performed to intermediate format data generated by software, the intermediate format data may not be recognized correctly in some printers that are print output destinations. In such a case, printing based on the intermediate format data is not performed successfully.

The followings are reference documents.

### [Document 1] Japanese Laid-open Patent Publication No. 2002-215361,

### [Document 2] Japanese Laid-open Patent Publication No. 2003-296214,

### [Document 3] Japanese Laid-open Patent Publication No. 2008-152545,

### [Document 4] Japanese Laid-open Patent Publication No. 2006-318245,

### [Document 5] Japanese Laid-open Patent Publication No. 2011-146008, and

### [Document 6] Japanese Laid-open Patent Publication No. 2012-78998.

### SUMMARY

According to an aspect of the embodiments, a printing data output method executed by a server device, which causes the server device to execute a process includes receiving first intermediate format data generated based on printing data from a terminal, identifying one or more printers in response to reception of information on a print output destination of the printing data, determining whether the first intermediate format data matches the printer, generating second intermediate format data that matches the printer from the first intermediate format data in accordance with a result of the determination, and transmitting, to the printer, the second intermediate format data or print format data converted by the server device based on the second intermediate format data when the second intermediate format data is generated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a print output system;

FIG. 2 is a diagram illustrating an example of a terminal;

FIG. 3 is a diagram illustrating an example of a server device;

FIG. 4 is a diagram illustrating an example of a printer;

FIG. 5 is a diagram illustrating description examples of tags;

FIG. 6 is a diagram illustrating a generation example of second intermediate format data;

FIG. 7 is a diagram illustrating a conversion example based on a table;

FIG. 8 is a diagram illustrating a conversion example based on another table;

FIG. 9 is a diagram illustrating a conversion example based on another table;

FIG. 10 is a diagram illustrating an example of a first print processing pattern;

FIG. 11 is a first flowchart illustrating an example of a flow of processing of the first print processing pattern;

FIG. 12 is a second flowchart illustrating the example of the flow of the processing of the first print processing pattern;

FIG. 13 is a third flowchart illustrating the example of the flow of the processing of the first print processing pattern;

FIG. 14 is a diagram illustrating an example of a second print processing pattern;

FIG. 15 is a first flowchart illustrating an example of flow of processing the second print processing pattern;

FIG. 16 is a second flowchart illustrating the example of the flow of the processing of the second print processing pattern;

FIG. 17 is a third flowchart illustrating the example of the flow of the processing of the second print processing pattern;

FIG. 18 is a fourth flowchart illustrating the example of the flow of the processing of the second print processing pattern;

FIG. 19 is a diagram illustrating an example of a third print processing pattern;

FIG. 20 is a first flowchart illustrating an example of a flow of processing of the third print processing pattern;

FIG. 21 is a second flowchart illustrating the example of the flow of the processing of the third print processing pattern;

FIG. 22 is a first flowchart illustrating a flow of conversion processing;

FIG. 23 is a second flowchart illustrating the flow of the conversion processing;

FIG. 24 is a diagram illustrating table examples of another piece of conversion processing;

FIG. 25 is a diagram illustrating a conversion example of the other piece of conversion processing;

FIG. 26 is a first flowchart illustrating an example of a flow of the other piece of conversion processing;

FIG. 27 is a second flowchart illustrating the example of the flow of the other piece of conversion processing;

FIG. 28 is a flowchart illustrating an example of a flow of processing in a modification;

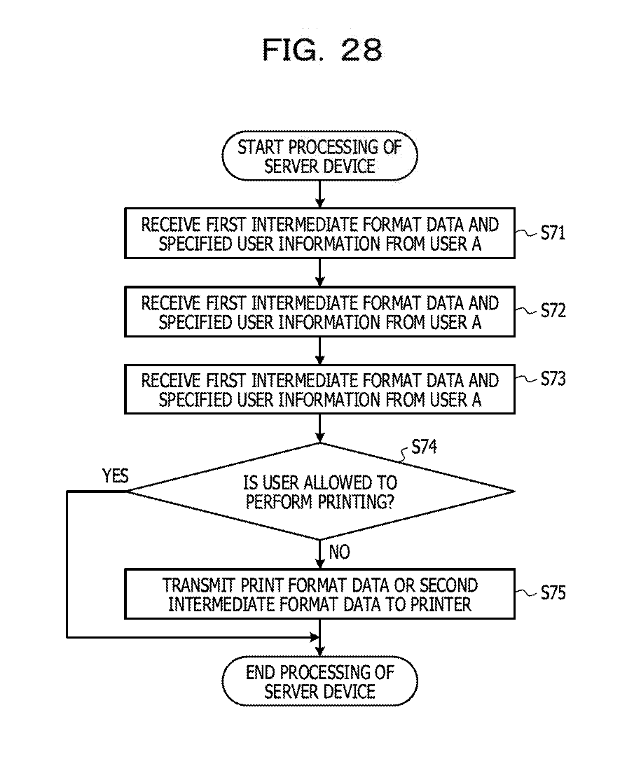

FIG. 29 is a diagram illustrating an example of a hardware configuration of the terminal;

FIG. 30 is a diagram illustrating an example of a hardware configuration of the server device; and

FIG. 31 is a diagram illustrating an example of a hardware configuration of the printer.

### DESCRIPTION OF EMBODIMENTS

### Example of Overall Configuration of System According to Embodiment

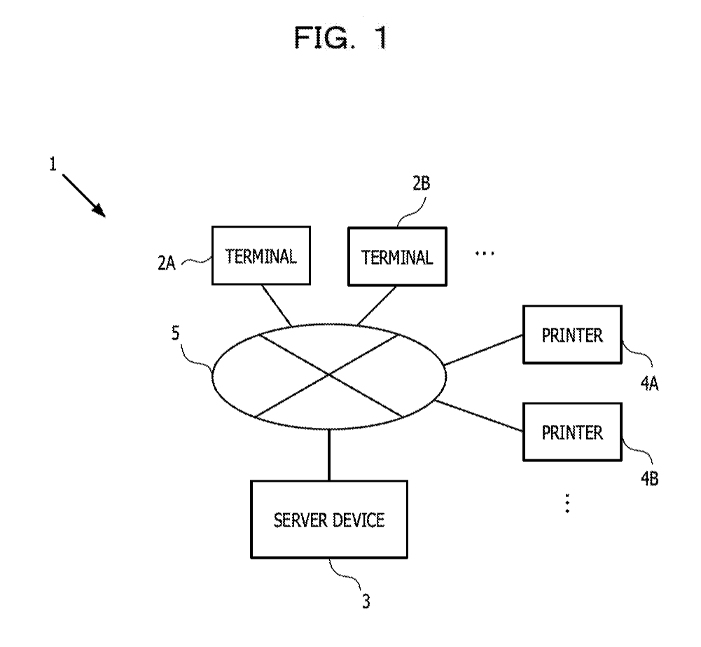

FIG. 1 illustrates an example of a print output system 1 according to an embodiment. In the print output system 1, a plurality of terminals 2 (2A, 2B, . . . ), a server device 3, and a plurality of printers 4 (4A, 4B, . . . ) are coupled to each other via a network 5.

A single terminal 2 may be coupled to the network 5. The plurality of printers 4 coupled to the network 5 are managed by the server device 3.

The terminal 2 is a terminal that instructs the printer 4 to perform certain printing. The server device 3 receives a print instruction from the terminal 2 and causes the printer 4 that is an output destination to perform printing. In the embodiment, a plurality of types of printers 4 are coupled to the network 5. For example, printers 4 of different venders (supply sources) or models are coupled to the network 5.

The terminal 2 is a certain computer. For example, the terminal 2 may be a personal computer, a tablet terminal, a smartphone, or the like. The terminal 2 according to the embodiment is a thin client terminal having few hardware resources. However, the terminal 2 is not limited to a thin client terminal.

The printer 4 may be a printer specialized for a print function or a multifunction machine or the like obtained by adding a facsimile function, a copy function, or the like to the print function. The printer 4 according to the embodiment is a multifunction machine. However, the printer 4 is not limited to a multifunction machine.

The network 5 according to the embodiment is an Internet network. However, the network 5 may be an internal network such as a local area network (LAN) or a wide area network (WAN).

The terminal 2 generates first intermediate format data for causing a printer 4 to perform certain printing, and transmits the generated first intermediate format data to the server device 3. The server device 3 converts the first intermediate format data received from the terminal 2 into second intermediate format data that matches a printer 4 that is a print output destination (hereinafter may be referred to as an output destination).

Thus, second intermediate format data that that matches the printer 4 that is the print output destination is generated. Hereinafter, first intermediate format data and second intermediate format data may be collectively referred to as intermediate format data.

In the embodiment, two stages of intermediate format data such as first intermediate format data and second intermediate format data are generated. The intermediate format data may be, for example, extensible markup language (XML) paper specification (XPS) based on an XML.

The intermediate format data is highly versatile printing data allowed to be interpreted in a plurality of types of printers 4. The server device 3 transmits intermediate format data or print format data to the printer 4 that is the print output destination. The print format data is printing data that matches the printer 4 that is the print output destination. The print format data may be, for example, a page description language (PDL).

### Example of Terminal

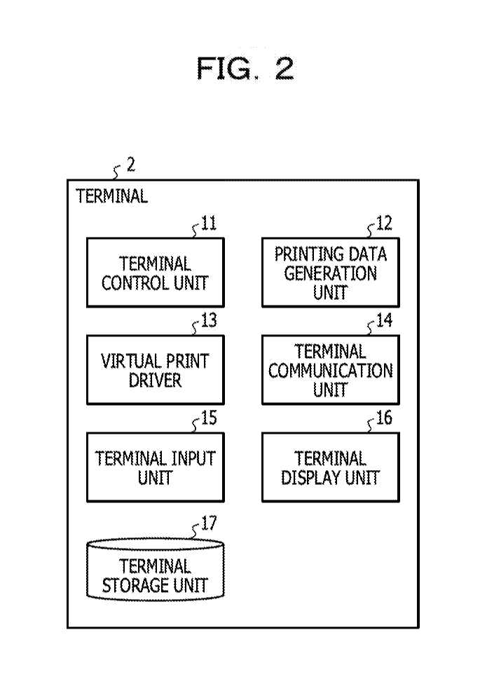

FIG. 2 illustrate an example of the terminal 2. The terminal 2 includes a terminal control unit 11, a printing data generation unit 12, a virtual print driver 13, a terminal communication unit 14, a terminal input unit 15, a terminal display unit 16, and a terminal storage unit 17.

The terminal control unit 11 performs various controls of the terminal 2. The printing data generation unit 12 generates printing data. For example, the printing data is document data, image data, or the like generated by a certain application program (hereinafter referred to as software) executed by the terminal 2.

The virtual print driver 13 generates first intermediate format data from the printing data generated by the printing data generation unit 12. For example, the virtual print driver 13 may be realized by the print function of the above-described software.

The terminal communication unit 14 communicates with the server device 3 via the network 5. The terminal input unit 15 is an input unit that accepts certain input to the terminal 2. For example, the terminal input unit 15 may be a keyboard, a mouse, and the like.

The terminal display unit 16 is a display unit that displays certain information. For example, the terminal display unit 16 may be a display or the like. The terminal input unit 15 and the terminal display unit 16 are integrated into an integrated-type touch panel display or the like. The terminal storage unit 17 stores certain information.

### Example of Server Device

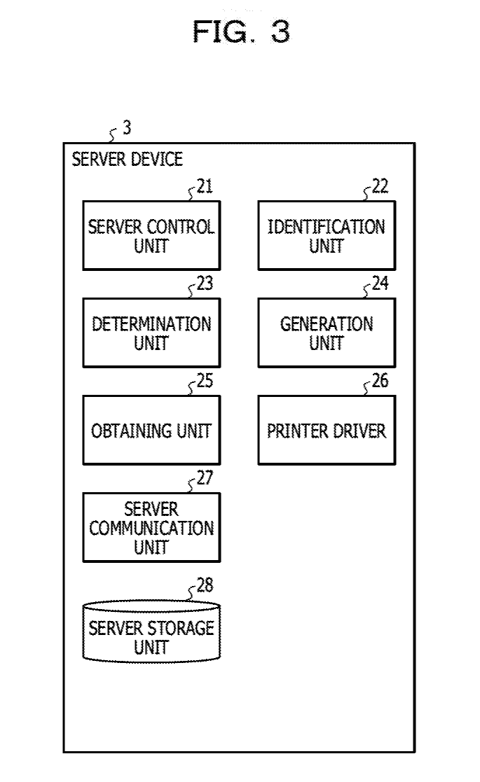

FIG. 3 illustrates an example of the server device 3. The server device 3 includes a server control unit 21, an identification unit 22, a determination unit 23, a generation unit 24, an obtaining unit 25, a printer driver 26, a server communication unit 27, and a server storage unit 28.

The server control unit 21 performs various controls of the server device 3. The identification unit 22 identifies a printer 4 that is a print output destination of printing data generated by the printing data generation unit 12 of the terminal 2, in accordance with information from the terminal 2 or information from the printer 4.

The determination unit 23 determines whether the first intermediate format data received from the terminal 2 matches the identified printer 4 that is the print output destination. The generation unit 24 converts the first intermediate format data into second intermediate format data in accordance with the result of the determination by the determination unit 23.

The first intermediate format data received from the terminal 2 is stored in the server storage unit 28. The obtaining unit 25 obtains the first intermediate format data stored in the server storage unit 28. The printer driver 26 converts the second intermediate format data into print format data that matches the printer 4 that is the print output destination.

For example, the printer driver 26 is a program that generates print format data that matches the printer 4 that is the print output destination, and the program is stored in the server storage unit 28 in accordance with the number of types of printers 4 that are print output destinations. The server device 3 may not include the function of the printer driver 26.

The server communication unit 27 communicates with the terminal 2 and the printer 4 via the network 5. The server communication unit 27 is an example of a communication unit. The server storage unit 28 stores certain information. The server storage unit 28 is an example of a storage unit.

The server storage unit 28 may be realized by a device different from a device including the other units in the server device 3. When the function of the server device 3 is realized by a plurality of devices, distribution of the load and improvement of availability, for example, suppression of service halt caused by device failure may be realized.

### Example of Printer

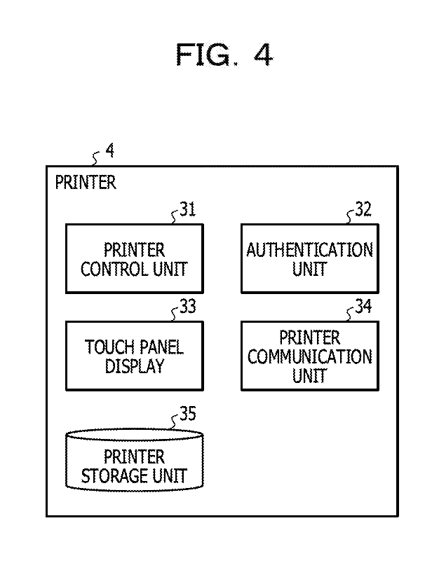

FIG. 4 illustrates an example of the printer 4. The printer 4 includes a printer control unit 31, an authentication unit 32, a touch panel display 33, a printer communication unit 34, and a printer storage unit 35. The printer control unit 31 performs various controls of the printer 4. For example, the printer control unit 31 performs printing on a certain paper sheet (printing paper or the like) by controlling a printer mechanism built in the printer 4.

The authentication unit 32 performs authentication (user authentication) of whether a user who operates the printer 4 has legitimate authority. Therefore, the authentication unit 32 recognizes user information for identifying a user who operates the printer 4.

For example, when a card reader is installed in the printer 4, the card reader performs short-range wireless communication with a non-contact type card owned by the user, and then, the authentication unit 32 may recognize the user information. When the touch panel display 33 accepts input of the user information, the authentication unit 32 may recognize the user information in accordance with the accepted input.

The touch panel display 33 includes a display function and an input function. The display function and the input function may be realized by different devices. For example, the display function may be realized by a display, and the input function may be realized by a key or the like.

The printer communication unit 34 communicates with the server device 3 via the network 5. The printer storage unit 35 stores certain information.

### Description Examples of Tags

Description examples of tags are described below. Intermediate format data includes one or more pieces of information on print setting (print setting information). In the embodiment, the print setting information is realized by a tag included in the intermediate format data. The print setting information may be realized by information other than a tag.

In the embodiment, intermediate format data is data having the above-described XPS format. However, the intermediate format data is not limited to the XPS format.

In the case of the XPS format, a tag indicating print setting is described in a certain area called a print ticket area in the intermediate format data. A description of the tag (print setting specification) may not match a printer 4 that is a print output destination. In this case, printing is not performed successfully in the printer 4.

For example, in the print ticket area, a tag that conforms to a certain rule is described. A tag that does not conform to the above-described rule may be described in the first intermediate format data in some virtual print drivers 13 of terminals 2. A unique tag that does not conform to the above-described rule may be described in an area other than the print ticket area.

Even when a tag that conforms to the rule is described in the first intermediate format data generated by the virtual print driver 13 of the terminal 2, the printer 4 that is the print output destination may not interpret the first intermediate format data correctly. In such a case, printing is not performed successfully in the printer 4.

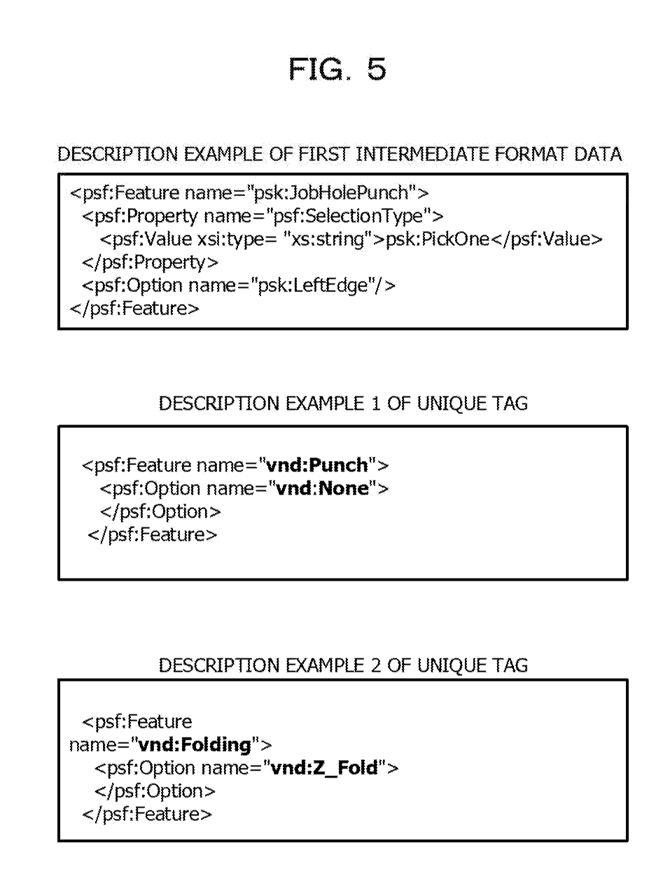

In FIG. 5, “description example of first intermediate format data” is an example of first intermediate format data that conforms to the above-described rule. In “description example of the first intermediate format data”, print setting that indicates processing to open a punch hole in a printing paper is illustrated. First intermediate format data is highly versatile printing data, and therefore, a degree of flexibility within print setting is low.

For example, in a case of print setting to open a punch hole, the number of variations of processing to open a punch hole is small. In “description example of the first intermediate format data” of FIG. 5, print setting to open a punch hole at the left edge of a printing paper is illustrated (“psk:LeftEdge” in FIG. 5).

For example, when the user who operates the terminal 2 performs operation to specify print setting to open punch holes at two locations of the printing paper by using the terminal input unit 15, the terminal 2 accepts such operation.

The virtual print driver 13 generates first intermediate format data in accordance with the specified print setting. The first intermediate format data includes a description of a tag that does not conform to the above-described rule. For example, in the example of FIG. 5, “description example 1 of unique tag” is an example of a description of print setting of processing of punch holes, which does not conform to the above-described rule.

In “description example 2 of unique tag” of FIG. 5, print setting indicating processing of Z fold is illustrated. In the above-described rule, print setting of processing of fold is not defined. Therefore, when print setting indicating processing of fold is specified, the virtual print driver 13 generates first intermediate format data including a description of a unique tag.

### Generation Example of Second Intermediate Format Data

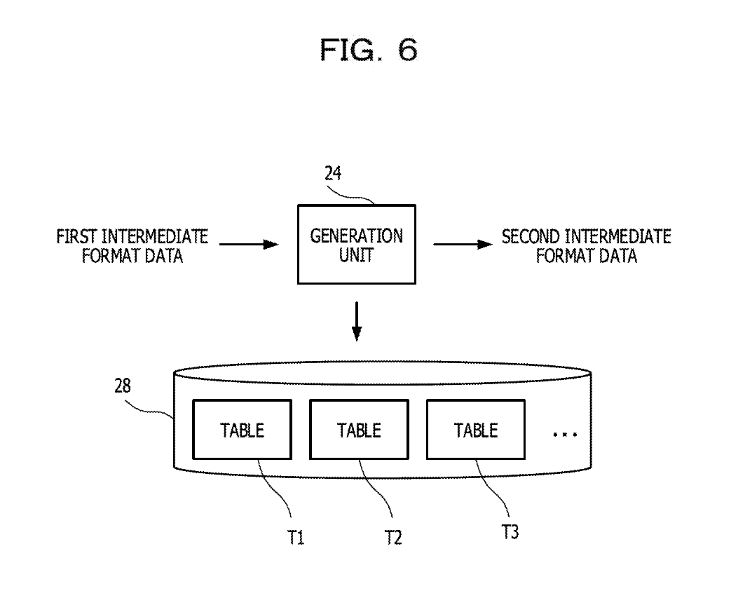

A generation example of second intermediate format data is described below with reference to FIG. 6. As illustrated in the example of FIG. 6, the generation unit 24 accepts input of first intermediate format data. The generation unit 24 converts the first intermediate format data into second intermediate format data with reference to a table corresponding to a printer 4 that is a print output destination from among a plurality of tables stored in the server storage unit 28. Due to the conversion, the second intermediate format data is generated.

The server device 3 receives information for determining a type of a printer 4 that is a print output destination of the first intermediate format data. For example, the information for determining the type of the printer 4 may be information for determining a vender or a model of the printer 4.

The table T (T1, T2, T3, . . . ) for each vender or each model of the printer 4 is stored in the server storage unit 28. The table T is a table for identifying a conversion target from first intermediate format data into second intermediate format data for each vender or model of the printer 4.

Hereinafter, the table T is described as a table for each vender, but the table T may be described as a table for each model of the printer 4. When the generation unit 24 converts first intermediate format data into second intermediate format data, a common conversion rule is applied to printers 4 of the same vender.

The server device 3 may receive, from the terminal 2, information (output destination information) for identifying a printer 4 that is a print output destination together with the first intermediate format data. The server device 3 may also receive output destination information from the printer 4. The output destination information is an example of information on a print output destination of printing data.

The generation unit 24 selects a table T corresponding to the received output destination information and identifies a tag that is a conversion target from among tags described in a print ticket area of the first intermediate format data with reference to the selected table T.

The server storage unit 28 stores a tag conversion program that matches a printer 4 indicated by the output destination information. The generation unit 24 performs conversion of the identified tag that is the conversion target by using the tag conversion program. As a result, the generation unit 24 generates second intermediate format data from the first intermediate format data.

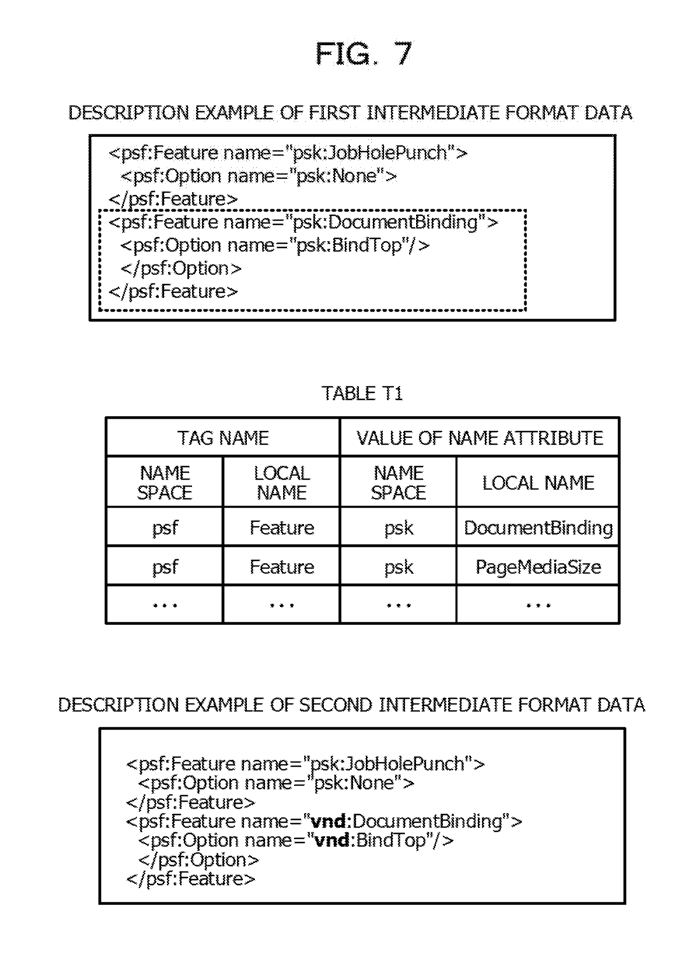

FIG. 7 is a diagram illustrating a conversion example of first intermediate format data based on the table T1. For example, it is assumed that the table T1 is a table for a vender A. When the output destination information indicates a printer 4 that belongs to the vender A, the generation unit 24 refers to the table T1.

For example, as illustrated in the example of FIG. 7, the table T includes items of a tag name and a value of a name attribute. The tag name and the value of the name attribute each include items of a name space and a local name. The tag name indicates the name of a tag. The value of the name attribute indicates a content of print setting.

In the example of FIG. 7, a description of a portion enclosed by the dotted line is a description having one meaning. In the example of FIG. 7, a description from “psf:Featur” to “/psf:Feature” is a description having one meaning (document binding). Hereinafter, a description having one meaning is referred to as “element”.

For example, in a description example of first intermediate format data of FIG. 7, an element of a portion enclosed by the dotted line corresponds to the table T1. The generation unit 24 converts the element into a format that matches print setting specification of the vender A. In the example of FIG. 7, “psk” is converted into “vnd”. As a result, second intermediate format data that matches the print setting specification of the vender A is generated.

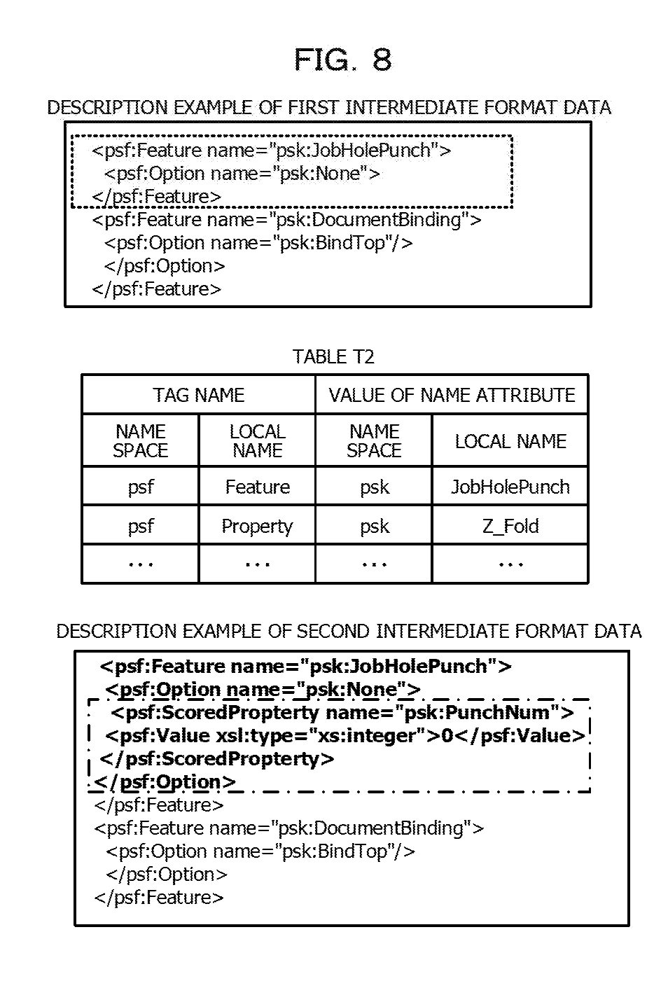

FIG. 8 is a diagram illustrating a conversion example of first intermediate format data based on the table T2. The table T2 is a table for a vender B. In a description example of first intermediate format data of FIG. 8, an element of a portion enclosed by the dotted line corresponds to the table T2.

The generation unit 24 converts the portion enclosed by the dotted line into a format that conforms to print setting specification of the vender B. In the example of FIG. 8, a description enclosed by the one-dot chain line is added to the first intermediate format data. As a result, second intermediate format data that conforms to the print setting specification of the vender B is generated.

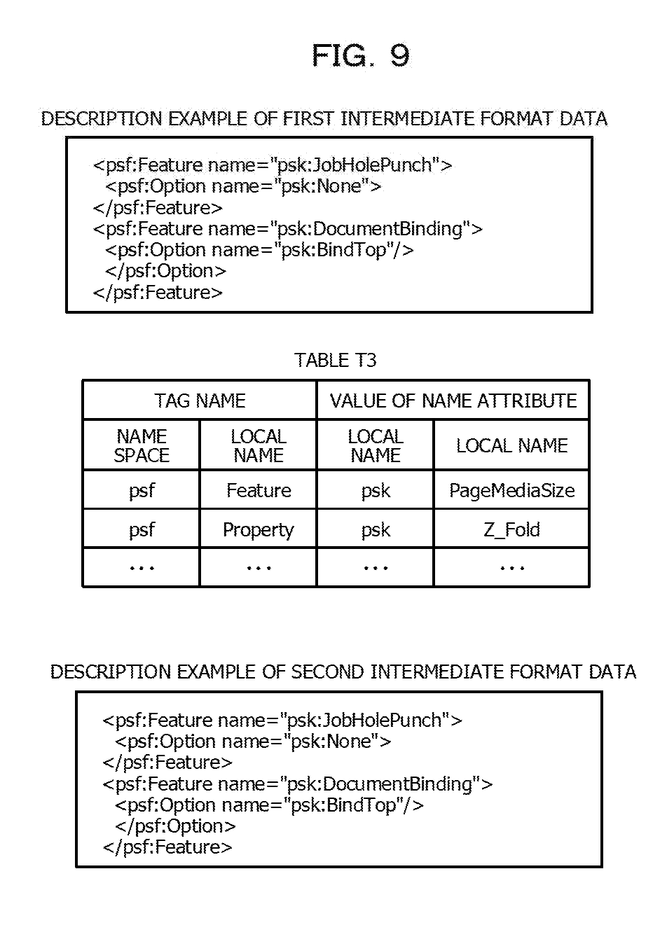

FIG. 9 is a diagram illustrating a conversion example of first intermediate format data based on the table T3. The table T3 is a table for a vender C. In a description example of first intermediate format data of FIG. 9, there is no element corresponding to the table T3. In this case, the generation unit 24 does not perform conversion of the first intermediate format data.

In each of the above-described examples, the generation unit 24 performs conversion of an element (tag) of the first intermediate format data to generate second intermediate format data, but, for example, the generation unit 24 may perform conversion of data using a tree structure or a key-value as print setting of the first intermediate format data.

### Example of First Print Processing Pattern

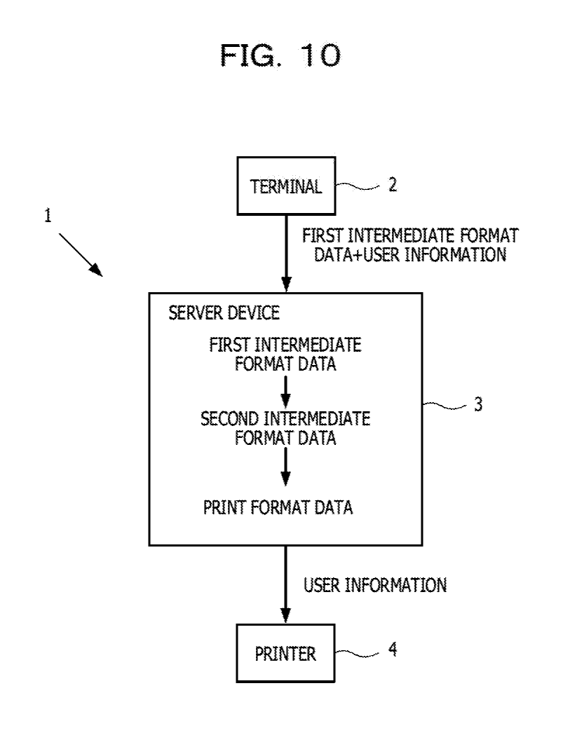

FIG. 10 is a diagram illustrating an example of a first print processing pattern. In the print output system 1 in the example of FIG. 10, the terminal 2 transmits output destination information and first intermediate format data to the server device 3. As a result, a print instruction is transmitted from the terminal 2 to the server device 3.

In the print output system 1 in the example of FIG. 10, the server device 3 generates second intermediate format data from the first intermediate format data and converts the generated second intermediate format data into print format data. Next, the server device 3 transmits the print format data to a printer 4 identified by the output destination information.

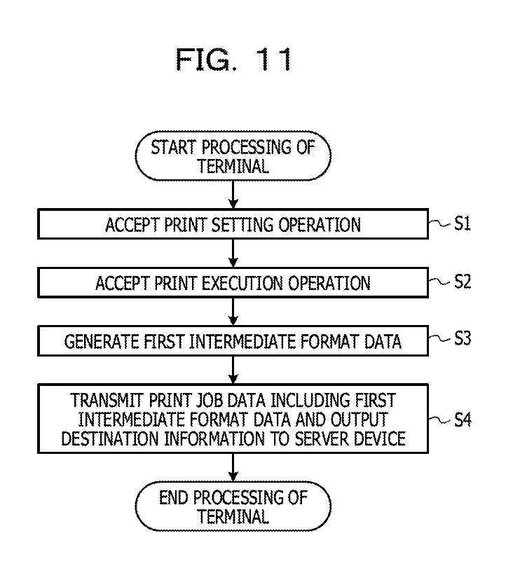

A flow of processing of the first print processing pattern is described below. FIG. 11 is a flowchart illustrating an example of a flow of processing of the terminal 2 in the first print processing pattern. For example, the user who operates the terminal 2 performs operation to start certain software (for example, document creation software or the like) on the terminal input unit 15.

The terminal 2 accepts such operation and starts the specified software. When print setting operation of the started software is performed on the terminal 2, the terminal 2 accepts the print setting operation (Step S1).

Such print setting operation includes operation to specify a printer 4 that is a print output destination. As a result, the terminal 2 recognizes output destination information. Print setting based on the accepted print setting operation may not match the printer 4 that is the print output destination.

When print execution operation is performed on the terminal 2, the terminal 2 accepts the print execution operation (Step S2). In this case, the printing data generation unit 12 generates printing data. The printing data may be a single piece of data (for example, document data) or include a plurality of pieces of data (for example, document data and image data).

The virtual print driver 13 generates first intermediate format data based on the printing data (Step S3). The terminal communication unit 14 of the terminal 2 transmits, to the server device 3, print job data including the first intermediate format data and the output destination information as a print instruction (Step S4). Such print job data may include user information for identifying a user.

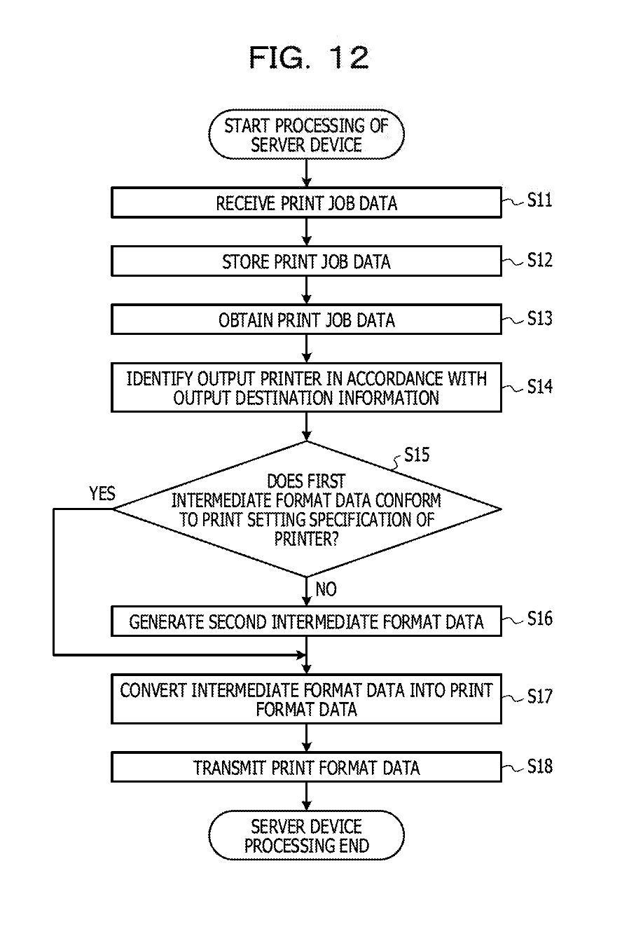

A flow of processing of the server device 3 in the first print processing pattern is described below with reference to FIG. 12. The server communication unit 27 receives print job data (Step S11). The server control unit 21 stores the received print job data in the server storage unit 28 (Step S12).

Next, the server control unit 21 obtains the print job data stored in the server storage unit 28 (Step S13). Due to the storage of the print job data in the server storage unit 28, for example, retransmission of print format data may be performed even when transmission of the print format data from the server device 3 to a printer 4 is not performed successfully.

The print job data includes the output destination information. The identification unit 22 identifies a printer 4 that is a print output destination (output printer) in accordance with the output destination information (Step S14). Next, the determination unit 23 determines whether first intermediate format data conforms to print setting specification of the identified printer 4 (Step S15).

For example, the server storage unit 28 stores a correspondence relationship between print setting specification of a printer 4 (for example, print setting specification of a vender) and intermediate format data, the determination unit 23 may perform the determination in Step S15 in accordance with the correspondence relationship.

When NO is determined in Step S15, the first intermediate format data does not match the print setting specification of the printer 4 that is the print output destination. In this case, the generation unit 24 converts the first intermediate format data into second intermediate format data that conforms to the print setting specification of the printer 4 that is the print output destination (Step S16).

When YES is determined in Step S15, the first intermediate format data conforms to the print setting specification of the printer 4 that is the print output destination. Therefore, the processing of Step S16 is not executed.

The printer driver 26 converts the first intermediate format data or the second intermediate format data to generate print format data (Step S17). The print format data is printing data that matches the printer 4 that is the print output destination.

When NO is determined in Step S15, the printer driver 26 converts the first intermediate format data into the print format data. When YES is determined in Step S15, the printer driver 26 converts the second intermediate format data into the print format data. The server communication unit 27 transmits the generated print format data to the printer 4 that is the print output destination indicated by the output destination information (Step S18).

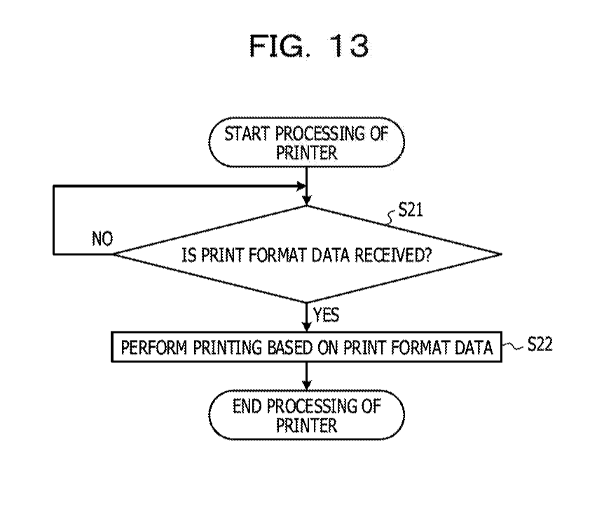

A flow of processing the printer 4 in the first print processing pattern is described below with reference to FIG. 13. The printer control unit 31 determines whether the printer communication unit 34 has received print format data (Step S21). When NO is determined in Step S21, the processing does not proceed to the next step.

When YES is determined in Step S21, the printer communication unit 34 receives the print format data from the server device 3. The print format data is printing data that matches the printer 4. The printer control unit 31 controls print execution in accordance with the print format data. As a result, printing based on the print format data is performed (Step S22).

In the first print processing pattern, the terminal 2 transmits, to the server device 3, the output destination information together with the first intermediate format data. In a second print processing pattern and a third print processing pattern described below, the terminal 2 does not perform transmission of output destination information. The terminal 2 transmits, to the server device 3, user information for identifying a user together with the first intermediate format data.

### Example of Second Print Processing Pattern

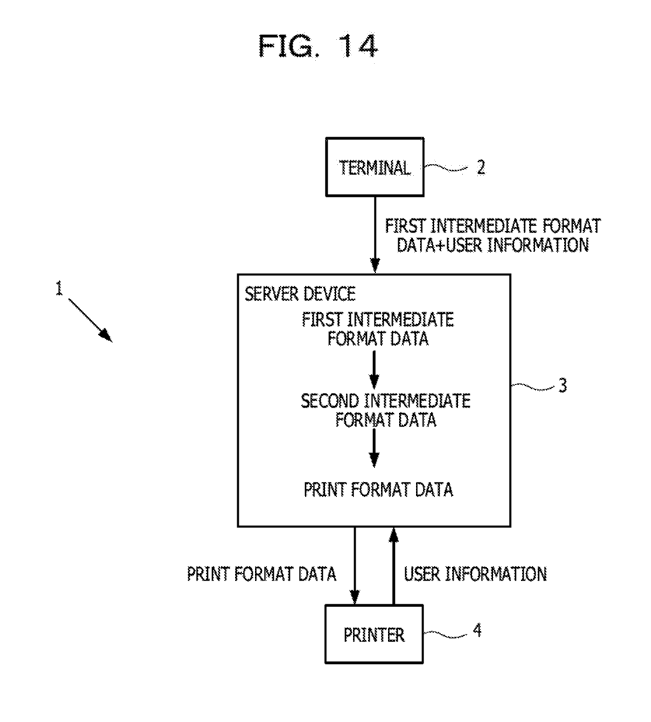

FIG. 14 is a diagram illustrating an example of the second print processing pattern. In the print output system 1 in the example of FIG. 14, the terminal 2 transmits user information together with first intermediate format data to the server device 3. The server device 3 stores the received first intermediate format data associated with the user information in the server storage unit 28.

As illustrated in the print output system 1 in the example of FIG. 14, the printer 4 transmits the user information to the server device 3. For example, it is assumed that the user who has performed print setting operation and print execution operation on the terminal 2 performs authentication operation, operation on the touch panel display 33, or the like in a printer 4 that is a print output destination.

For example, when authentication operation is performed, the authentication unit 32 performs authentication to recognize user information for which the authentication has been performed. Alternatively, when information for identifying a user is input to the touch panel display 3, the user information is recognized.

The printer control unit 31 transmits the recognized user information to the server device 3. The server device 3 refers to user information stored in the server storage unit 28 in response to reception of the user information from the printer 4.

Next, the server device 3 obtains first intermediate format data associated with the received user information. The server device 3 generates second intermediate format data from the obtained first intermediate format data and converts the generated second intermediate format data into print format data. After that, the server device 3 transmits the print format data to the printer 4 that is the transmission source of the user information.

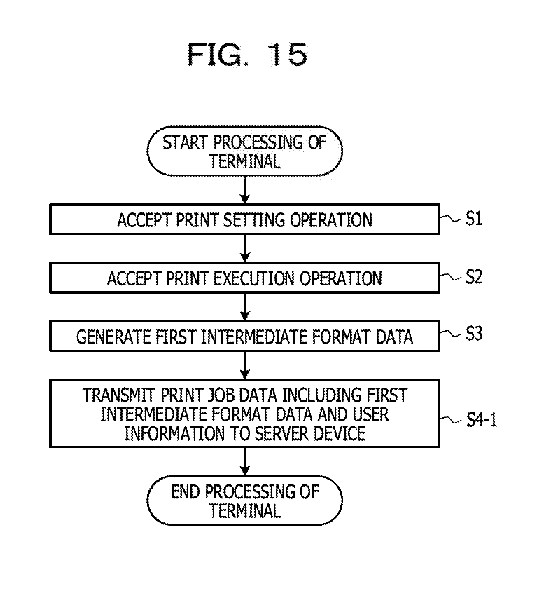

A flow of processing of the second print processing pattern is described below. FIG. 15 is a flowchart illustrating an example of a flow of processing of the terminal 2 in the second print processing pattern. The processing other than Step S4-1 is similar to that of FIG. 11, and therefore, a duplicated description is omitted herein. The terminal communication unit 14 of the terminal 2 transmits print job data including first intermediate format data and user information to the server device 3 (Step S4-1).

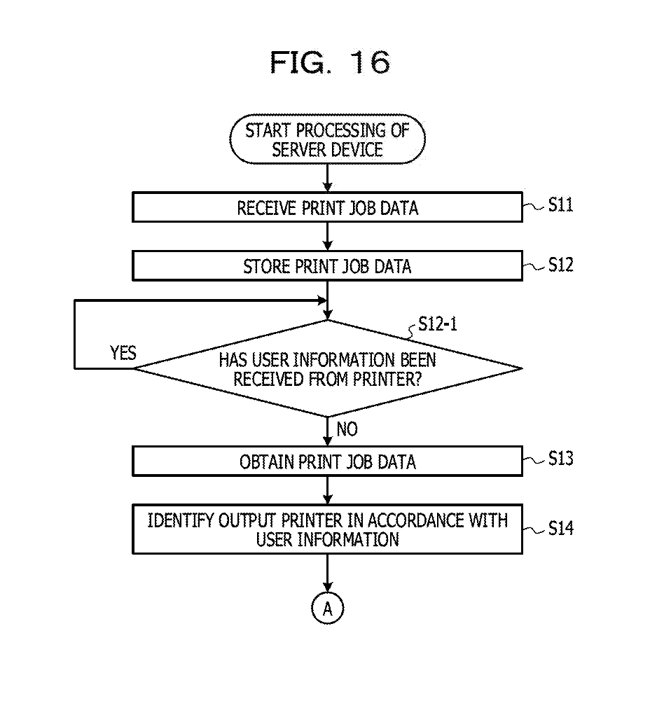

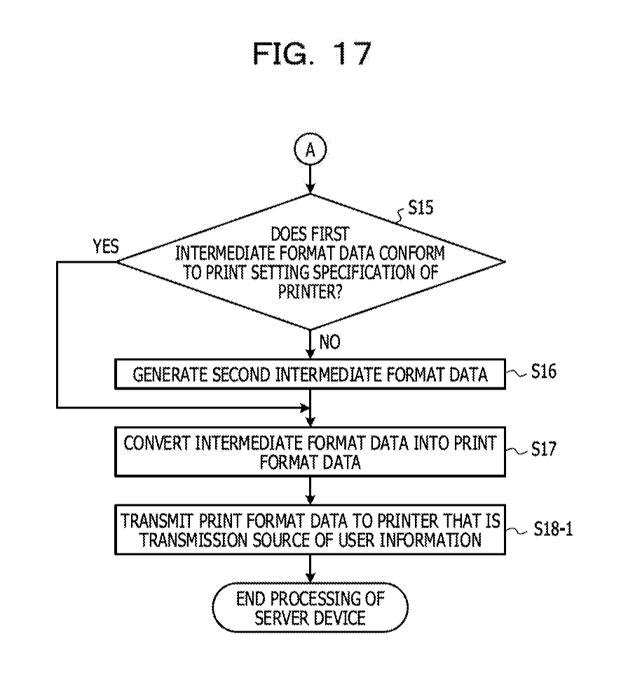

An example of a flow of processing of the server device 3 in the second print processing pattern is described below with reference to FIGS. 16 and 17. The server communication unit 27 receives the print job data from the terminal 2 (Step S11).

The server control unit 21 stores the received print job data in the server storage unit 28 (Step S12). The print job data includes first intermediate format data and user information, and therefore, the first intermediate format data and the user information are associated with each other and stored in the server storage unit 28.

The server control unit 21 determines whether user information has been received from the printer 4 (Step S12-1). When NO is determined in Step S12-1, the processing does not proceed to the next step. When YES is determined in Step S12-1, the obtaining unit 25 obtains first intermediate format data associated with the received user information from the server storage unit 28 (Step S13).

The identification unit 22 identifies the printer 4 as an output printer in accordance with the user information received from the printer 4 (Step S14). For example, the printer 4 may transmit, to the server device 3, a network address of the printer 4 together with the user information.

The identification unit 22 identifies the printer 4 that is the transmission source of the network address as the output printer in accordance with the received network address. In FIG. 16, the processing proceeds “A”. The processing of “A” and the subsequent steps is described below with reference to FIG. 17.

The determination unit 23 determines whether the first intermediate format data conforms to print setting specification of the identified printer 4 (Step S15). When NO is determined in Step S15, the generation unit 24 converts the first intermediate format data into second intermediate format data that conforms to the print setting specification of the printer 4 that is the print output destination (Step S16).

When YES is determined in Step S15, the generation unit 24 does not execute the processing of Step S16. The printer driver 26 converts the first intermediate format data or the second intermediate format data into print format data (Step S17).

The server communication unit 27 transmits the generated print format data to the printer 4 that is the transmission source of the user information (Step S18-1). For example, as described above, when the printer 4 transmits a network address together with user information, the server communication unit 27 transmits the print format data to the printer 4 that is the print output destination indicated by the network address.

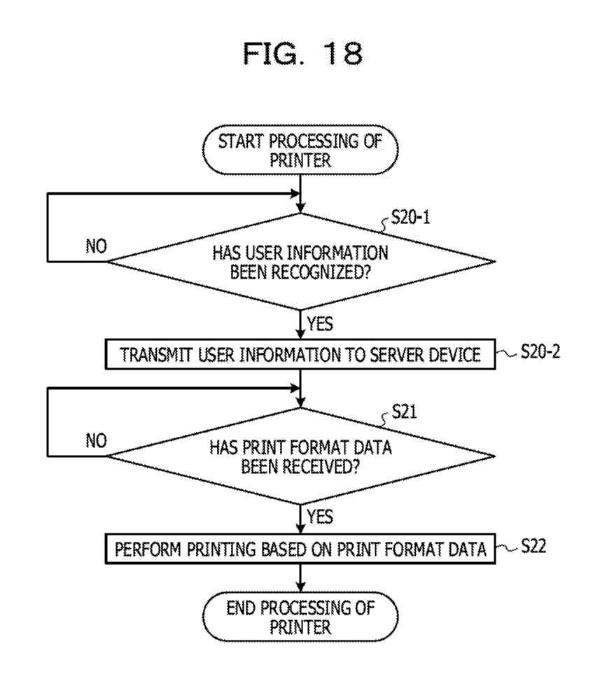

A flow of processing of the printer 4 in the second print processing pattern is described below with reference to FIG. 18. The printer control unit 31 determines whether user information has been recognized (Step S20-1). For example, when the touch panel display 33 accepts input of user information or when the authentication unit 32 performs authentication (user authentication), the printer control unit 31 determines that the user information has been recognized.

When NO is determined in Step S20-1, the processing does not proceed to the next step. When YES is determined in Step S20-1, the user information is recognized.

The printer communication unit 34 transmits the user information to the server device 3 (Step S20-2). At this time, the printer communication unit 34 may transmit the above-described network address together with the user information to the server device 3.

The printer control unit 31 determines whether the printer communication unit 34 has received print format data (Step S21). When NO is determined in Step S21, the processing does not proceed to the next step.

When YES is determined in Step S21, the printer communication unit 34 receives the print format data from the server device 3. The printer control unit 31 controls print execution in accordance with the print format data. As a result, printing based on the print format data is performed (Step S22).

In the second print processing pattern, the terminal 2 transmits, to the server device 3, user information together with the first intermediate format data, and the server device 3 stores the first intermediate format data. For example, when the network 5 is an Internet network, the terminal 2 transmits (uploads), to the server device 3, the first intermediate format data and the user information.

In this case, even when a printer driver compatible with a printer 4 that is a print output destination is not installed in the terminal 2, the terminal 2 may cause a certain printer to perform printing successfully. For example, even when a location to which the terminal 2 transmits first intermediate format data is far from a location in which the printer 4 is installed, printing that conforms to the print setting specification of the printer 4 is performed.

As described above, the user may cause a printer 4 installed in a certain location to perform printing based on the uploaded first intermediate format data. Therefore, for example, not a printer 4 having a long latency time from among a plurality of printers 4, but a printer 4 having a short latency time may be caused to perform printing.

Here, a plurality of pieces of print job data may be transmitted from the terminal 2 to the server device 3. In this case, the server storage unit 28 of the server device 3 stores a plurality of pieces of first intermediate format data associated with user information.

As described above, when input of user information by using the touch panel display 33 or user authentication by the authentication unit 32 is performed on the printer 4, the printer 4 transmits the user information and the network address to the server device 3.

The server device 3 may obtain a plurality of first intermediate format data associated with the received user information from the server storage unit 28 and transmit a list (job list) of the a plurality of pieces of first intermediate format data to the printer 4 that is the transmission source of the user information.

The printer 4 displays the received job list on the touch panel display 33 in response to reception of the job list. As a result, the user may select first intermediate format data to be printed from the job list displayed on the touch panel display 33.

When the touch panel display 33 accepts selection of first intermediate format data, the touch panel display 33 transmits information for specifying the selected first intermediate format data to the server device 3. As a result, the server device 3 may identify first intermediate format data to be printed. The same processing is applied to the third print processing pattern described below.

### Example of Third Print Processing Pattern

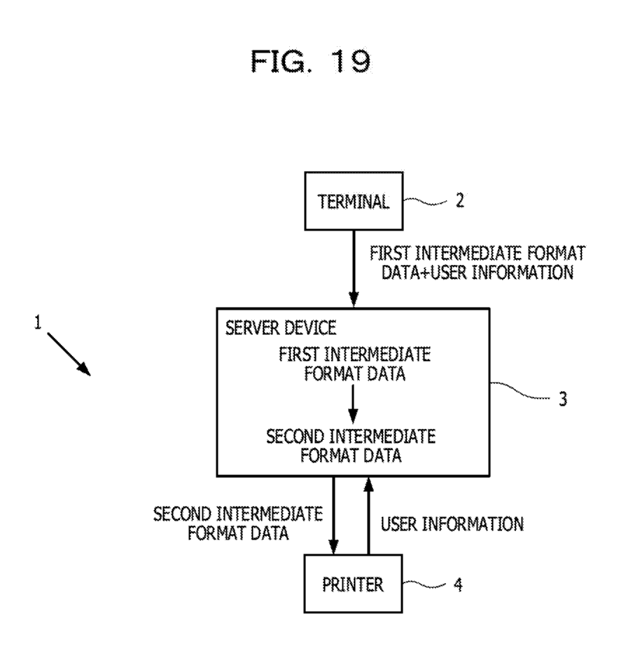

FIG. 19 is a diagram illustrating an example of the third print processing pattern. The example in the second print processing pattern is described above in which the server device 3 transmits print format data to a printer 4 that is a print output destination. In the print output system 1 in the third print processing pattern, the server device 3 transmits second intermediate format data to a printer 4 that is a print output destination.

The printer 4 that is the print output destination performs printing in accordance with the second intermediate format data. Therefore, in the print output system 1 in the third print processing pattern, it is assumed that the printer 4 that is the print output destination is a printer that performs printing based on intermediate format data. Hereinafter, the printer 4 that is the print output destination may interpret the intermediate format data.

As described above, the printer driver 26 converts second intermediate format data into print format data that matches a printer 4 that is a print output destination. Here, a plurality of printers 4 are coupled to the network 5. The printer driver 26 converts intermediate format data into print format data that matches the printer 4, and therefore, a plurality of printer drivers 26 are to be installed in the server device 3.

On the other hand, in the case of the third print processing pattern, print format data is not generated. The function of the printer driver 26 is not used, and therefore, the printer driver 26 is not installed in the server device 3. Thus, the number of printer drivers 26 installed in the server device 3 is reduced.

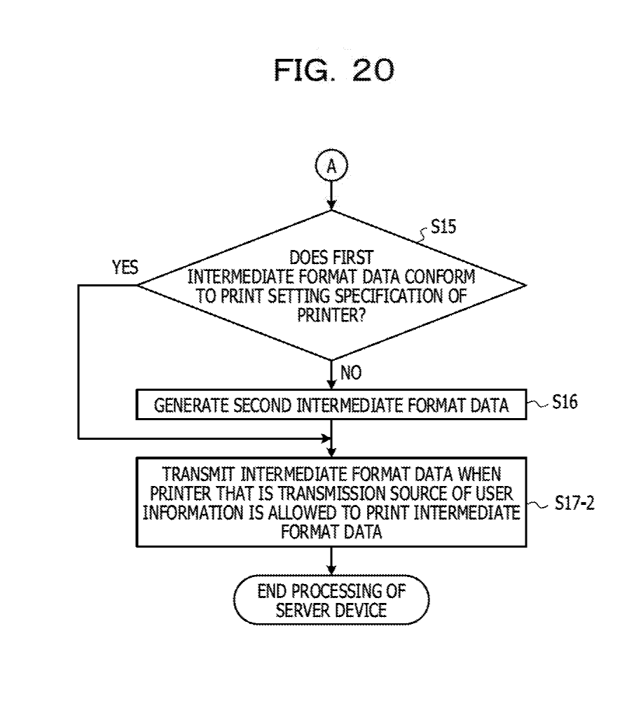

A flow of processing of the third print processing pattern is described below with reference to FIG. 20. The processing executed by the terminal 2 is similar to that of the second print processing pattern, and therefore, a duplicated description is omitted herein. Steps S11 to S16 in the processing executed by the server device 3 are similar to those of the second print processing pattern, and therefore, a duplicated description is omitted herein.

When the printer 4 that is the transmission source of the user information is allowed to perform printing of intermediate format data, the server device 3 transmits the intermediate format data to the printer 4 (Step S17-2). The intermediate format data is either first intermediate format data or second intermediate format data.

For example, for each printer 4, the server storage unit 28 stores information indicating whether intermediate format data is allowed to be printed. In this case, the server device 3 may determine whether the printer 4 that is the transmission source of the user information is allowed to perform printing of the intermediate format data with reference to the information stored in the server storage unit 28.

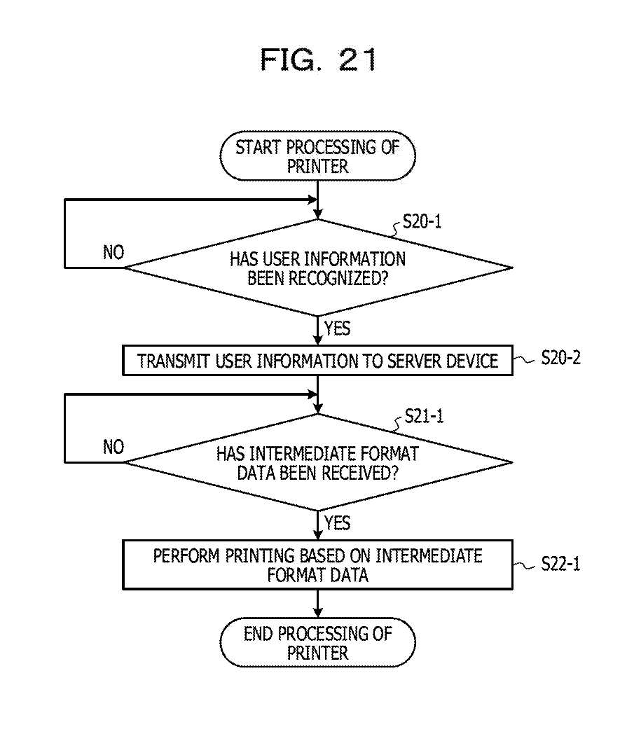

A flow of processing executed by the printer 4 is described below with reference to FIG. 21. Steps S20-1 and S20-2 are similar to those of the second print processing pattern, and therefore, a duplicated description is omitted herein. The printer control unit 31 determines whether the printer communication unit 34 has received intermediate format data (Step S21). When NO is determined in Step S21, the processing does not proceed to the next step.

When YES is determined in Step S21, the printer communication unit 34 receives first intermediate format data or second intermediate format data from the server device 3. The printer control unit 31 controls print execution in accordance with the received first intermediate format data or second intermediate format data. As a result, printing based on the intermediate format data is performed (Step S22-1).

### Example of Conversion Processing

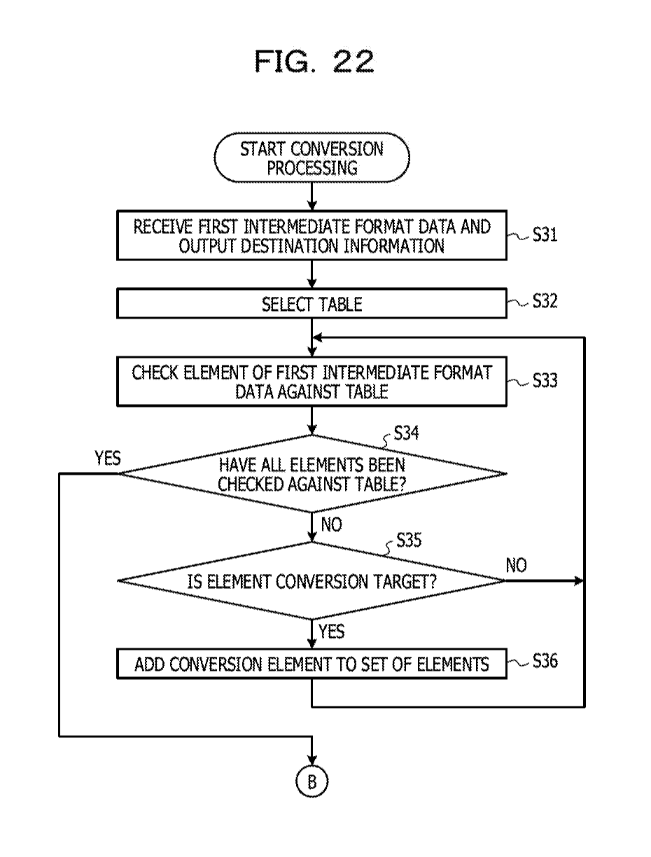

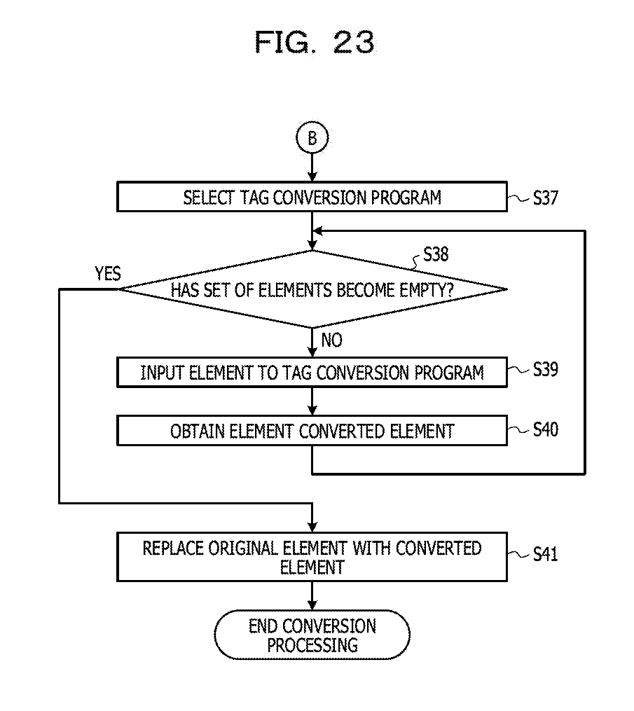

An example of conversion processing in which the generation unit 24 of the server device 3 performs conversion from first intermediate format data to second intermediate format data is described below. FIGS. 22 and 23 are flowcharts illustrating the example of the conversion processing.

The server communication unit 27 of the server device 3 receives first intermediate format data and output destination information (Step S31). The server communication unit 27 receives the first intermediate format data from a terminal 2. The server communication unit 27 receives the output destination information from the terminal 2 or a printer 4.

The generation unit 24 select a table T corresponding to the printer 4 that is the print output destination from among a plurality of tables T stored in the server storage unit 28 in accordance with the received output destination information (Step S32).

As described above, the identification unit 22 identifies the printer 4 that is the print output destination in accordance with the received output destination information, and the generation unit 24 selects, from the server storage unit 28, a table T corresponding to a vender to which the identified printer 4 belongs.

A tag of an XML described in the intermediate format data includes an element on print setting. The generation unit 24 checks each element of the first intermediate format data against the selected table T piece by piece (Step S33).

The generation unit 24 determines whether all elements included in the first intermediate format data has been checked against the selected table T (Step S34). When NO is determined in Step S34, the generation unit 24 determines whether an element that is a check target is an element that is a conversion target (Step S35).

When the element corresponds to the table T, the generation unit 24 determines the element to be an element that is a conversion target (conversion element). When NO is determined in Step S35, the generation unit 24 adds the conversion element to a set of the elements (Step S36).

As described above, an element is a description having one meaning (print setting). The element may include a plurality of tags. In the embodiment, in a table T, a tag of an element is defined. As a result, when the element that is the check target is added to the set of the elements, tags included in the element that is the check target are also collectively added to the set of the elements.

In the embodiment, a tag of an element and one or more tags included in the element are related to each other. The tag is an example of print setting information.

After the processing in Step S36 ends or when YES is determined in Step S35, the processing returns to Step S33. When NO is determined in Step S34, the processing proceeds to “B”. The processing in “B” and the subsequent steps is described below with reference to FIG. 23.

The generation unit 24 converts the first intermediate format data into second intermediate format data that matches the printer 4 that is the print output destination. In the embodiment, the conversion is performed by the tag conversion program. A tag conversion program for each table T is stored in the server storage unit 28 in accordance with the table T.

As described above, a table T for each vender is stored in the server storage unit 28. Thus, a tag conversion program for each vender is also stored in the server storage unit 28. A tag conversion program is a program corresponding to a vender. The tag conversion program may be a program corresponding to a model of the printer 4.

The generation unit 24 selects a tag conversion program corresponding to a vender to which a printer 4 that is a print output destination indicated by output destination information belongs from among tag conversion programs stored in the server storage unit 28 (Step S37).

The generation unit 24 obtains an element from a set of elements. The generation unit 24 determines whether the set of the elements has become empty (Step S38). When NO is determined in Step S38, the generation unit 24 inputs the obtained element to the tag conversion program (Step S39).

The tag conversion program converts the obtained element into an element that conforms to print setting specification of second intermediate format data. The generation unit 24 obtains the converted element (Step S40). After that, the processing returns to Step S38. Until the set of the elements becomes empty, the processing in Step S39 and S40 is executed.

When YES is determined in Step S38, in descriptions of tags of the first intermediate format data, a description corresponding to each of the elements added to the set of elements is replaced with the converted element (Step S41). As a result, the generation unit 24 generates second intermediate format data from the first intermediate format data. Thus, a tag of an element and one or more tags included in the element are collectively converted by the tag conversion program.

### Example of Another Piece of Conversion Processing

An example of another piece of conversion processing is described below. In the example of the other piece of conversion processing, the generation unit 24 extracts the above-described element from descriptions of tags of first intermediate format data, and converts the element into function data. The function data is structural data based on the above-described element, and represents a function of print setting indicated by the element.

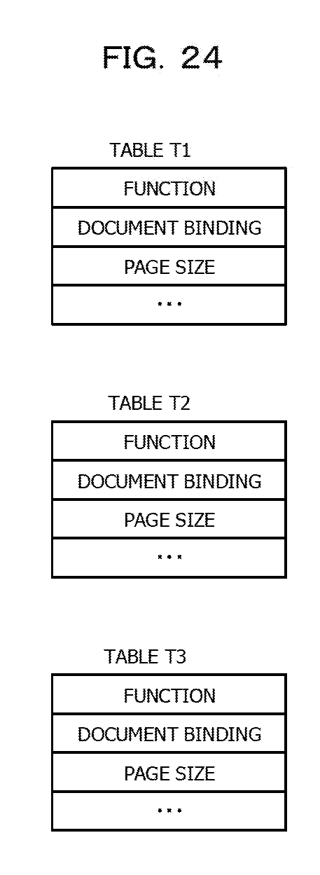

FIG. 24 illustrates examples of tables T1 to T3 in the other piece of conversion processing. For example, in the table T1, “document binding” and “page size” are defined.

In a case in which second intermediate format data is generated from first intermediate format data in accordance with the table T1, when an element indicating a function of print setting of “document binding” is included in descriptions of tags of the first intermediate format data, the element is converted by a tag conversion program.

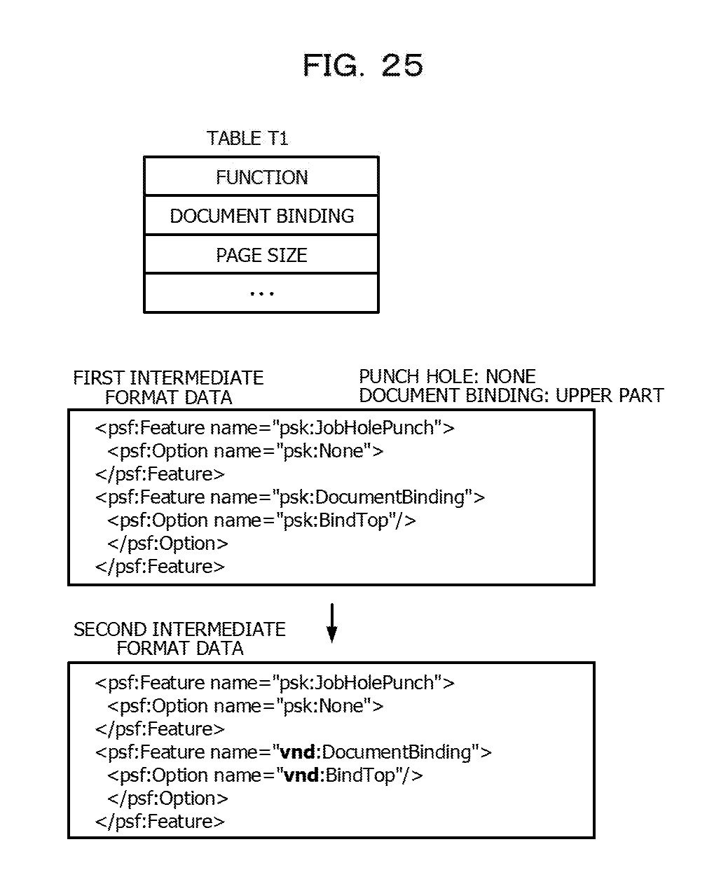

FIG. 25 is a diagram illustrating a conversion example of the other piece of conversion processing. The first intermediate format data includes an element indicating that print setting related to “hole punch” is not performed and an element indicating that print setting related to “document binding” (“DocumentBinding” in the example of FIG. 25) corresponds to a top part of the document. In the example of the other piece of conversion processing, function data of the hole punch and the document binding is generated from the first intermediate format data.

As illustrated in the table T1 of FIG. 25, “document binding” and “page size” are defined in the table T1. Here, function data of “document binding” is generated from the first intermediate format data. The generation unit 24 converts an element related to the document binding in the first intermediate format data into second intermediate format data that matches a printer 4 that is a print output destination by the tag conversion program.

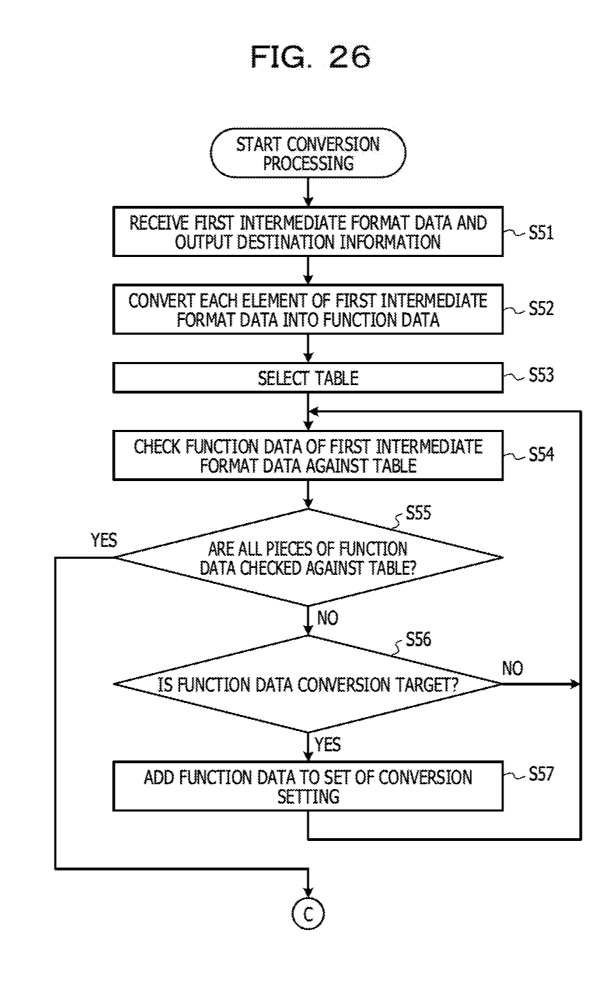

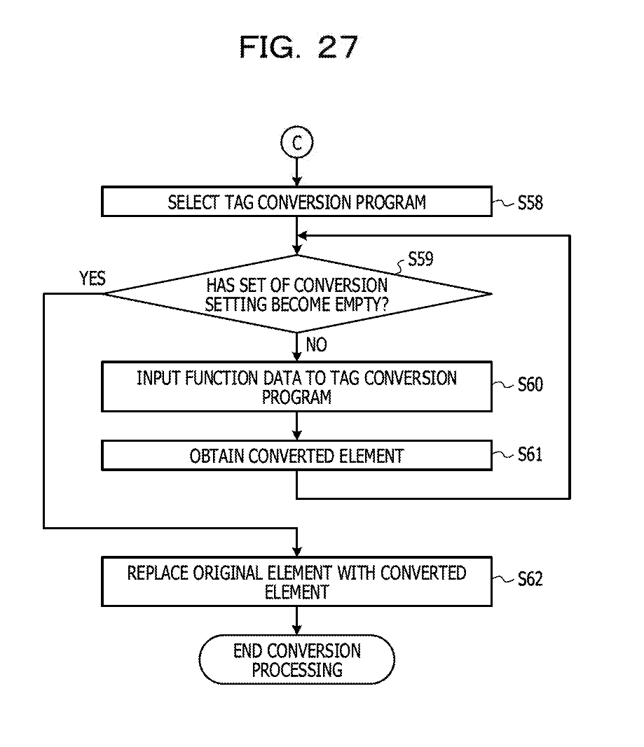

FIGS. 26 and 27 are flowcharts illustrating the example of the other piece of conversion processing. The server communication unit 27 of the server device 3 receives first intermediate format data and output destination information (Step S51). The generation unit 24 converts each element included in descriptions of tags of the first intermediate format data into function data (Step S52).

The generation unit 24 selects a table T corresponding to the printer 4 that is the print output destination from among a plurality of tables T stored in the server storage unit 28 in accordance with received output destination information (Step S53). Next, the generation unit 24 checks each piece of function data of the first intermediate format data against a selected table T piece by piece (Step S54).

The generation unit 24 determines whether all pieces of function data of the first intermediate format data are checked against the selected table T (Step S55). When NO is determined in Step S55, the generation unit 24 determines whether function data that is a check target is function data that is a conversion target (Step S56).

When the function data corresponds to the table T, the generation unit 24 determines the function data to be function data that is a conversion target. When YES is determined in Step S35, the generation unit 24 adds the function data that is the check target as conversion setting to a set of conversion setting (Step S57). Function data that is not a conversion target (for example, “Punch hole: none” in the example of FIG. 25) is not added to the set of the conversion setting.

After the processing in Step S57 ends or when NO is determined in Step S56, the processing returns to Step S54. When NO is determined in Step S55, the processing proceeds to “C”. The processing in “C” and the subsequent steps is described below with reference to FIG. 27.

The generation unit 24 selects a tag conversion program corresponding to a vender to which the printer 4 that is the print output destination indicated by output destination information belongs from tag conversion programs stored in the server storage unit 28 (Step S58).

The generation unit 24 obtains function data from the set of the conversion setting. The generation unit 24 determines whether the set of the conversion setting has become empty (Step S59). When NO is determined in Step S59, the generation unit 24 inputs the obtained function data to the tag conversion program (Step S60).

The tag conversion program converts the obtained function data into an element that conforms to print setting specification of second intermediate format data. The generation unit 24 obtains the converted element (Step S61). After that, the processing returns to Step S59. Until a set of elements becomes empty, the processing in Steps S60 and S61 is executed.

When YES is determined in Step S59, from among descriptions of tags of the first intermediate format data, a description of an element corresponding to each piece of function data added to the set of the conversion setting is replaced with the converted element (Step S62). As a result, the generation unit 24 generates the second intermediate format data from the first intermediate format data.

### Modification

A modification is described below. In the modification, user information that the server device 3 receives from the terminal 2 is different from user information that the server device 3 receives from the printer 4. Hereinafter, the user who operates the terminal 2 is a user A.

The user A who operates the terminal 2 specifies a user who is allowed to perform printing when the user A performs print setting operation and print execution operation on the terminal 2. Hereinafter, in the modification, the specified user is a user B.

The terminal 2 accepts specification of the user B. The terminal 2 transmits, to the server device 3, specified user information (information indicating the specified user B) together with the first intermediate format data. The server device 3 receives the first intermediate format data and the specified user information (Step S71).

The server control unit 21 stores the first intermediate format data and the specified user information associated with each other in the server storage unit 28 (Step S72). For example, when the user B performs user authentication in the printer 4, the authentication unit 32 recognizes user information indicating the user B. The printer communication unit 34 transmits the user information to the server device 3.

The server device 3 receives the user information indicating the user B from the printer 4 (Step S73). With reference to the specified user information stored in the server storage unit 28, the server control unit 21 determines whether the received user information is included in the specified user information (Step S74). As a result, the server control unit 21 determines whether the user information received from the printer 4 corresponds to a user who is allowed to perform printing.

When YES is determined in Step S74, the server communication unit 27 transmits print format data or second intermediate format data to the printer 4 (Step S75). As a result, printing is performed in the printer 4. When NO is determined in Step S74, the processing in Step S75 is not executed.

When the user A causes the user B to perform printing of printing data generated by the terminal 2, for example, the terminal 2 of the user A may transmit, to the terminal 2 of the user B, an e-mail to which the printing data is attached. In this case, the printing data is stored in the terminal 2 of the user B as well, and therefore, the printing data is highly likely to be leaked.

On the other hand, in the modification, printing data is not transmitted to the terminal 2 of the user B, and therefore, the printing data is not likely to be leaked.

In the above-described case, it is assumed that software compatible with the printing data is installed in the terminal 2 of the user B in order to perform printing of the printing data in the terminal 2 of the user B. In the modification, the server device 3 generates second intermediate format data that matches a printer 4 that is a print output destination from first intermediate format data.

Therefore, even when software for printing the printing data is not installed in the terminal 2 of the user B, the printing data may be printed.

Here, the first intermediate format data is transmitted from the terminal 2 to the server device 3. Print setting is performed to the first intermediate format data. Therefore, the user B may perform printing in accordance with certain print setting without print setting operation.

The server device 3 may transmit second intermediate format data or print format data together with user information to a printer 4 that is a print output destination at certain timing. When the printer recognizes the same user information as the received user information (when user authentication is performed or operation to input user information is accepted), the printer 4 may perform printing. As a result, the user may perform the printing at certain timing.

### Example of Hardware Configuration of Terminal

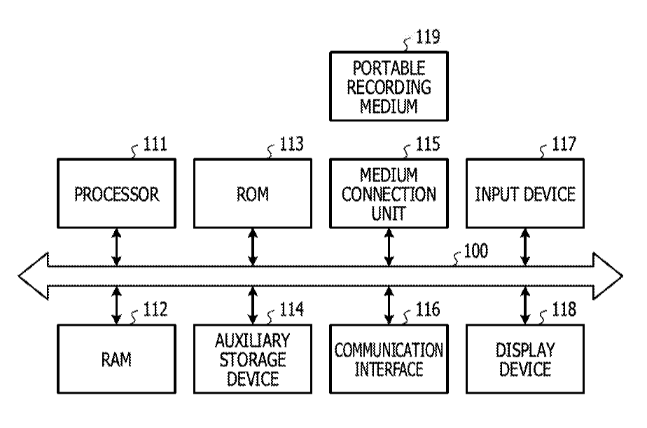

An example of a hardware configuration of the terminal 2 is described with reference to FIG. 29. As illustrated in the example of FIG. 29, a processor 111, a random access memory (RAM) 112, and a read only memory (ROM) 113 are coupled to a bus 100.

An auxiliary storage device 114, a medium connection unit 115, a communication interface 116, an input device 117, and a display device 118 are also coupled to the bus 100. The processor 111 executes a program deployed to the RAM 112. As a program to be executed, a program for executing the processing in the embodiment may be applied.

The ROM 113 is a nonvolatile storage device that stores the program deployed to the RAM 112. The auxiliary storage device 114 is a storage device that stores various pieces of information, and, for example, a semiconductor memory or the like may be applied as the auxiliary storage device 114.

The medium connection unit 115 is allowed to be coupled to a portable recording medium 119. When the terminal 2 is a thin client terminal, the auxiliary storage device 114 and the medium connection unit 115 may not be included in the terminal 2.

As the portable recording medium 119, a portable memory may be applied. A program for executing the processing in the embodiment may be recorded in the portable recording medium 119.

The terminal storage unit 17 may be realized by the RAM 112, the auxiliary storage device 114, or the like. The terminal communication unit 14 may be realized by the communication interface 116. The terminal input unit 15 may be realized by the input device 117. The terminal display unit 16 may be realized by the display device 118.

The terminal control unit 11, the printing data generation unit 12, and the virtual print driver 13 may be realized by causing the processor 111 to execute a certain program.

The RAM 112, the ROM 113, the auxiliary storage device 114, and the portable recording medium 119 are examples of a computer-readable tangible storage medium. These tangible storage mediums are not temporary mediums such as signal carrier waves.

### Example of Hardware Configuration of Server Device

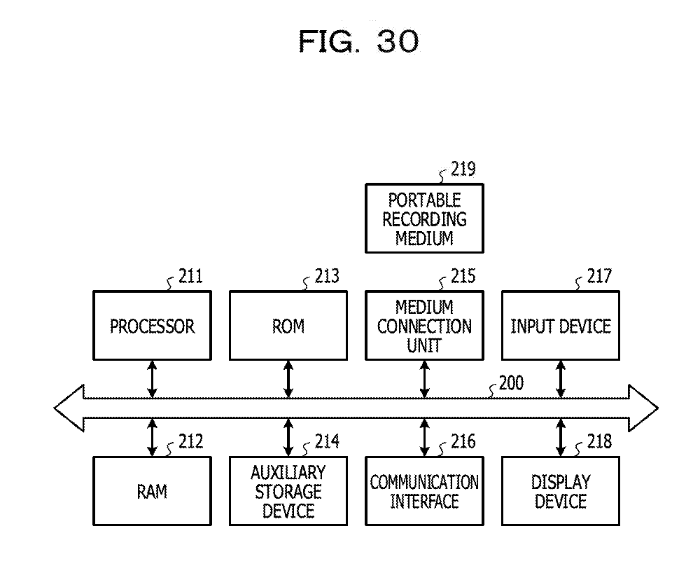

An example of a hardware configuration of the server device 3 is described with reference to FIG. 30. As illustrated in the example of FIG. 30, a processor 211, a RAM 212, and a ROM 213 are coupled to a bus 200.

An auxiliary storage device 214, a medium connection unit 215, a communication interface 216, an input device 217, and a display device 218 are also coupled to the bus 200. The processor 211 executes a program deployed to the RAM 212. As a program to be executed, a program for executing the processing in the embodiment may be applied.

The ROM 213 is a nonvolatile storage device that stores the program deployed to the RAM 212. The auxiliary storage device 214 is a storage device that stores various pieces of information, and, for example, a hard disk, a semiconductor memory, or the like may be applied as the auxiliary storage device 214. The medium connection unit 215 is allowed to be coupled to a portable recording medium 219.

As the portable recording medium 219, a portable memory, an optical disk (for example, a compact disc (CD) or a digital versatile disc (DVD)), or the like may be applied. A program for executing the processing in the embodiment may be recorded in the portable recording medium 219.

The server storage unit 28 may be realized by the RAM 212, the auxiliary storage device 214, or the like. The server communication unit 27 may be realized by the communication interface 216. The server control unit 21, the identification unit 22, the determination unit 23, the generation unit 24, the obtaining unit 25 and the printer driver 26 may be realized by causing the processor 211 to execute a certain program.

The RAM 212, the ROM 213, the auxiliary storage device 214, and the portable recording medium 219 are examples of computer-readable tangible storage mediums. These tangible storage mediums are not temporary mediums such as signal carrier waves.

### Example of Hardware Configuration of Printer

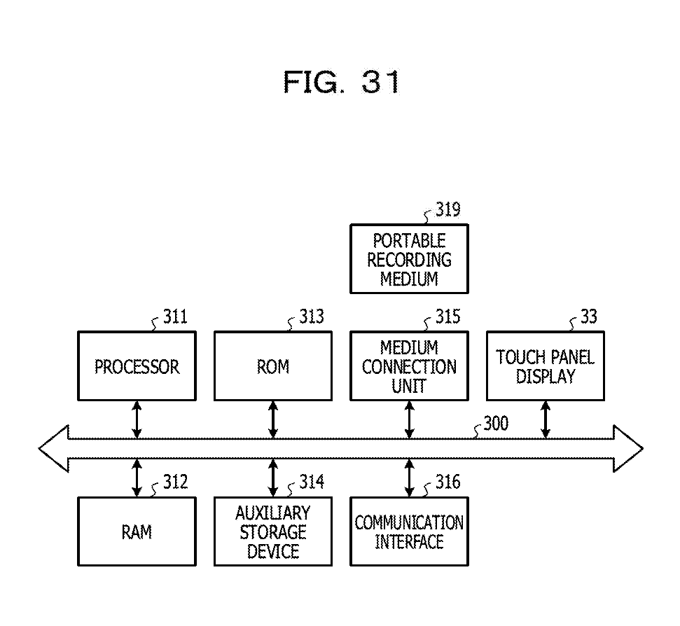

An example of a hardware configuration of the printer 4 is described below with reference to the example of FIG. 31. As illustrated in the example of FIG. 31, a processor 311, a RAM 312, and a ROM 313 are coupled to a bus 300.

An auxiliary storage device 314, a medium connection unit 315, a communication interface 316, and the touch panel display 33 are also coupled to the bus 300. The processor 311 executes a program deployed to the RAM 312. As the program to be executed, a program for executing the processing in the embodiment may be applied.

The ROM 313 is a nonvolatile storage device that stores the program deployed to the RAM 312. The auxiliary storage device 314 is a storage device that stores various pieces of information, and for example, a hard disk, a semiconductor memory, or the like may be applied as the auxiliary storage device 314. The medium connection unit 315 is allowed to be coupled to the portable recording medium 319.

As the portable recording medium 319, a portable memory, an optical disk (for example, a CD or a DVD), or the like may be applied. A program for executing the processing in the embodiment may be recorded in the portable recording medium 319.

The printer storage unit 35 may be realized by the RAM 312, the auxiliary storage device 314, or the like. The printer communication unit 34 may be realized by the communication interface 316. The printer control unit 31 and the authentication unit 32 may be realized by causing the processor 311 to execute a certain program.

The RAM 312, the ROM 313, the auxiliary storage device 314, and the portable recording medium 319 are examples of a computer-readable tangible storage medium. These tangible storage mediums are not temporary mediums such as signal carrier waves.

### Other Embodiments

As described above, in the embodiment, the server device 3 generates second intermediate format data that matches a printer 4 that is a print output destination from first intermediate format data received from the terminal 2 and transmits, to the printer 4, the second intermediate format data or print format data based on the second intermediate format data.

As a result, even when the first intermediate format data generated by the terminal 2 does not match the printer 4 that is the print output destination, the printer 4 may perform printing in accordance with the second intermediate format data generated by the server device 3 or the print format data.

For example, when the terminal 2 is a thin client terminal, it is difficult to install a printer driver compatible with a plurality of printers 4 in the terminal 2. In the embodiment, it is only sufficient that a printer driver (virtual print driver 13) for printing the first intermediate format data is installed in the terminal 2, and a plurality of printer drivers may not be installed in the terminal 2.

Therefore, even when a plurality of printer drivers are not installed in the terminal 2, a certain printer 4 may be caused to perform printing successfully by using the printer 4 as a print output destination.

In the embodiment, it is only sufficient that the above-described virtual print driver 13 for printing the first format data is installed in the terminal 2. Therefore, when a printer 4 that is not recognized by the terminal 2 is caused to perform printing, a printer driver of the printer 4 may not be installed in the terminal 2.

Thus, even when the terminal 2 is not a thin client terminal, installation of a printer driver may be omitted.

The server device 3 does not only relay printing data to be transmitted from a terminal 2 to a printer 4 that is a print output destination, but also transmits, to the printer 4, second intermediate format data that matches the printer 4 that is the print output destination, which is generated from the first intermediate format data. Therefore, the terminal 2 may cause a certain printer 4 to perform printing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to, a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A printing data output method executed by a server device, which causes the server device to execute a process comprising:
receiving first intermediate format data generated based on printing data from a terminal;
identifying one or more printers in response to reception of information on a print output destination of the printing data;
determining whether the first intermediate format data matches the printer;
generating second intermediate format data that matches the printer from the first intermediate format data in accordance with a result of the determination; and
transmitting, to the printer, the second intermediate format data or print format data converted by the server device based on the second intermediate format data when the second intermediate format data is generated.

2. The printing data output method according to claim 1,
wherein the server device
stores the first intermediate format data in a storage unit and
obtains the first intermediate format data from the storage unit in response to the reception of the information on the print output destination of the printing data.

3. The printing data output method according to claim 1,
wherein the server device
determines whether the first intermediate format data matches the printer based on whether print setting specification of the printer has data of a format different from a format of the first intermediate format data.

4. The printing data output method according to claim 1,
wherein the server device
identifies the printer based on information by which the printer is specified, which is received together with the first intermediate format data from the terminal.

5. The printing data output method according to claim 2,
wherein the server device
receives, from the terminal, user information for identifying a user together with the first intermediate format data,
stores the first intermediate format data and the user information associated with each other in the storage unit,
obtains the first intermediate format data associated with the user information, which is stored in the storage unit, in response to reception of the user information from the printer, and
determines whether the obtained first intermediate format data matches the printer.

6. The printing data output method according to claim 5,
wherein, for each of a plurality of printers managed by the server device, the server device,
refers to the storage unit that stores information indicating whether printing based on the second intermediate format data is allowed to be performed and transmits the second intermediate format data to the printer when the information indicates that the printer is allowed to perform the printing based on the second intermediate format data.

7. The printing data output method according to claim 1,
wherein the server device
collectively converts, from among a plurality of pieces of print setting information included in the first intermediate format data, a plurality of pieces of print setting information associated with each other in accordance with a certain rule to generate the second intermediate format data.

8. The printing data output method according to claim 2,
wherein the server device
receives, from the terminal, user information for identifying one or more users who are allowed to perform printing of the printing data together with the first intermediate format data,
stores the user information and the first intermediate format data associated with each other in the storage unit,
determines whether a user who corresponds to the user information is a user who is allowed to perform printing of the printing data with reference to the storage unit in response to reception of the user information from the printer, and
transmits the second intermediate format data or the print format data to the printer in accordance with a result of the determination.

9. A non-transitory computer readable recording medium that stores therein a printing data output program for causing a server device to execute a process for outputting printing data, the process comprising:
receiving first intermediate format data generated based on printing data from a terminal;
identifying a printer in response to reception of information on a printing output destination of the printing data;
determining whether the first intermediate format data matches the printer;
generates second intermediate format data that matches the printer from the first intermediate format data in accordance with a result of the determination; and
transmitting, to the printer, the second intermediate format data or print format data converted by the server device based on the second intermediate format data when the second intermediate format data is generated.

10. A printing data output system comprising:
one or more terminals;
a plurality of printers coupled to the terminals via a network; and
a server device coupled to the terminals and the printers via the network, the server device including
a communication unit that receives first intermediate format data generated based on printing data from the terminal,
an identification unit that identifies a printer in response to reception of information on a print output destination of the printing data,
a determination unit that determines whether the first intermediate format data matches the printer, and
a generation unit that generates second intermediate format data that matches the printer from the first intermediate format data in accordance with a result of the determination,
wherein the communication unit transmits, to the printer, the second intermediate format data or print format data converted by the server based on the second intermediate format data when the second intermediate format data is generated.
